(19) United States
(12) Patent Application Publication
(10) Pub. No.: US 2010/0174581 A1
(43) Pub. Date: Jul. 8, 2010

(54) WORKFLOW MANAGEMENT APPARATUS, WORKFLOW MANAGEMENT METHOD, AND WORKFLOW MANAGEMENT PROGRAM EMBODIED ON A COMPUTER-READABLE MEDIUM

(75) Inventor: Takatoshi MOCHIZUKI, Kobe-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/652,065

(22) Filed: Jan. 5, 2010

(30) Foreign Application Priority Data
Jan. 6, 2009 (JP) 2009-000901

(51) Int. Cl. G06Q 10/00

(52) U.S. Cl. 705/9; 705/301

(57) ABSTRACT

In order to provide the information for allowing smooth execution of a plurality of processes defined by a workflow, a workflow management apparatus includes a workflow accepting portion to accept and store a workflow, an identification information obtaining portion to obtain identification information for identifying a worker, an execution workflow extracting portion to extract from the workflows an execution workflow which assigns a target process that is to be the object of execution to the worker of the obtained identification information, a schedule obtaining portion to obtain a schedule of a worker assigned to a post-process that comes later in sequential order than the target process defined by the execution workflow, a deadline deciding portion to decide on a deadline for the execution of the target process based on the obtained schedule, and a notifying portion to notify the decided deadline to the worker to whom the target process is assigned.

This application is based on Japanese Patent Application No. 2009-000901 filed with Japan Patent Office on Jan. 6, 2009, the entire content of which is hereby incorporated by reference.

### BACKGROUND OF THE INVENTION

1. Field of the Invention

The present invention relates to a workflow management apparatus, a workflow management method, and a workflow management program embodied on a computer-readable medium, and more specifically to a workflow management apparatus, a workflow management method, and a workflow management program embodied on a computer-readable medium for managing a workflow that defines a process executed by a plurality of persons in sequential order.

2. Description of the Related Art

In recent years, a system is known in which a document for circulation and the like is converted to the form of electronic data and the electronic data is passed along for viewing among a plurality of persons in sequential order. In this circulation system, a workflow is generated when the electronic data, the users who are to participate in the circulation, and the order of circulation are provided, and the electronic data will be made available for viewing in sequential order to the users designated to be the targeted persons of the circulation. Especially with a document and such that requires approval, a workflow that combines a circulation process and an approval process may be generated, and each of a plurality of persons may execute the processes according to the workflow so that a plurality of processes can be executed in sequential order and the progress information thereof can be managed.

Japanese Patent Laid-Open No. 10-21300 describes a technology in which a client computer formed by a workflow man-machine portion to input information used in a workflow by a user and a schedule system man-machine portion for the user to input a schedule, a server computer formed by a schedule system for managing the schedule of each user and a workflow system for managing the user as well as the work assignment for the user, and a network that connects the client computer and the server computer are provided, and in which a workflow is generated with the workflow system being coordinated with the schedule system, by having the workflow system make an inquiry to the schedule system about a schedule of a user at the time of creation of the workflow.

With the conventional technology, however, there are cases where the schedule is changed after the workflow is created and there is a problem that the work defined by the workflow may not proceed smoothly within the time frame determined by the generated workflow.

### SUMMARY OF THE INVENTION

The present invention is made to solve the above-described problem, and an object of the present invention is to provide a workflow management apparatus which is capable of providing the information to allow smooth execution of a plurality of processes defined by a workflow.

Another object of the present invention is to provide a workflow management method which is capable of providing the information to allow smooth execution of a plurality of processes defined by a workflow.

Still another object of the present invention is to provide a workflow management program embodied on a computer-readable medium which is capable of providing the information to allow smooth execution of a plurality of processes defined by a workflow.

To achieve the above-described objects, according to one aspect of the present invention, a workflow management apparatus includes a workflow accepting portion to accept and store a workflow that includes a plurality of processes whose order is determined in advance and respectively assigns each of the plurality of processes to one person who is selected from a plurality of workers, an identification information obtaining portion to obtain identification information for identifying a worker, an execution workflow extracting portion to extract from stored workflows an execution workflow which assigns a target process that is to be the object of execution to the worker of the identification information obtained, a schedule obtaining portion to obtain a schedule of a worker assigned to a post-process that comes later in sequential order than the target process defined by the execution workflow, a deadline deciding portion to decide on a deadline for the execution of the target process based on the obtained schedule, and a notifying portion to notify the decided deadline to the worker to whom the target process is assigned.

According to another aspect of the present invention, a workflow management method includes the steps of accepting and storing a workflow that includes a plurality of processes whose order is determined in advance and respectively assigns each of the plurality of processes to one person who is selected from a plurality of workers, obtaining identification information for identifying a worker, extracting from stored workflows an execution workflow which assigns a target process that is to be the object of execution to the worker of the identification information obtained, obtaining a schedule of a worker assigned to a post-process that comes later in sequential order than the target process defined by the execution workflow, deciding on a deadline for the execution of the target process based on the obtained schedule, and notifying the decided deadline to the worker to whom the target process is assigned.

According to a still further aspect of the present invention, a workflow management program embodied on a computer-readable medium causes a computer to execute the steps of accepting and storing a workflow that includes a plurality of processes whose order is determined in advance and respectively assigns each of the plurality of processes to one person who is selected from a plurality of workers, obtaining identification information for identifying a worker, extracting from stored workflows an execution workflow which assigns a target process that is to be the object of execution to the worker of the identification information obtained, obtaining a schedule of a worker assigned to a post-process that comes later in sequential order than the target process defined by the execution workflow, deciding on a deadline for the execution of the target process based on the obtained schedule, and notifying the decided deadline to the worker to whom the target process is assigned.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall schematic diagram of a workflow management system according to one embodiment of the present invention.

FIG. 2 is a block diagram showing one example of a hardware arrangement of a workflow management apparatus.

FIG. 3 is a functional block diagram showing one example of a function of a CPU (Central Processing Unit) provided in the workflow management apparatus.

FIG. 4 is a diagram illustrating one example of a format of a workflow.

FIG. 5 is a flow chart showing one example of the flow of a workflow management process.

FIG. 6 is a flow chart showing one example of the flow of a deadline decision process.

FIG. 7 is a flow chart showing one example of the flow of an all processing mode final deadline setting process.

### DESCRIPTION OF THE PREFERRED EMBODIMENT

The embodiment of the present invention will be described below with reference to the drawings. In the following description, the same or corresponding parts are denoted by the same reference characters. Their names and function are also the same. Thus, the detailed description thereof will not be repeated.

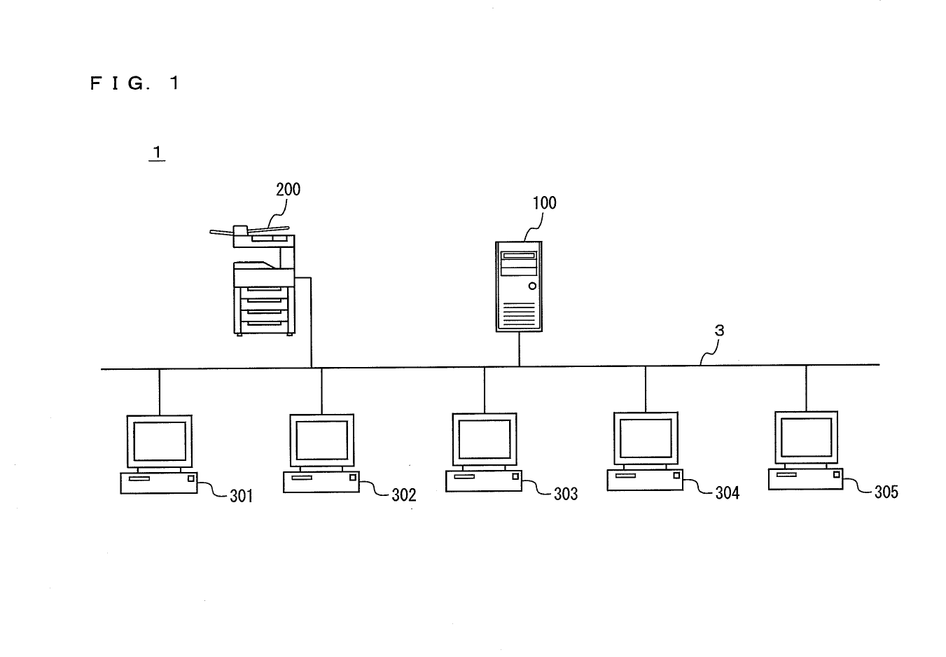

FIG. 1 is an overall schematic diagram of a workflow management system according to one embodiment of the present invention. With reference to FIG. 1, a workflow management system 1 includes a workflow management apparatus 100 that functions as a workflow management apparatus, personal computers (hereinafter referred to as “PCs”) 301 to 305, and an MFP (Multi Function Peripheral) 200.

Workflow management apparatus 100 and PCs 301 to 305 are common computers. The hardware arrangement and functions of PCs 301 to 305 are well known so that the description thereof will not be repeated here. MFP 200 is a multifunction apparatus which includes a scanner device for scanning a sheet of original manuscript, a facsimile device and an image forming device for forming an image on recording media such as a sheet of paper based on image data, and is provided with an image scanning function, a copying function, and a facsimile transmission and reception function.

Workflow management apparatus 100, five PCs 301 to 305, and MFP 200 are respectively connected to a network 3, and an IP (Internet Protocol) address is assigned to each of them as location information on network 3. Thus, workflow management apparatus 100, PCs 301 to 305, and MFP 200 are capable of communicating with one another via network 3 using the IP address assigned to the receiving end of the communication. Moreover, the location information on network 3 is not limited to an IP address and other addresses such as a MAC (Media Access Control) address and the like may be used as well.

In workflow management apparatus 100, a workflow management program for managing a workflow and a schedule management program for managing the schedule of each of a plurality of users are installed. The schedule management program is well known so that the description will not be repeated here. Workflow management apparatus 100 functions as a Web server for PCs 301 to 305 that serve as clients by executing the schedule management program, and stores a schedule in which scheduled future events for each of the plurality of users are allotted in chronological order based on the time and date of the scheduled events inputted from PCs 301 to 305.

Workflow management apparatus 100 functions as a Web server and responds to the accesses from PCs 301 to 305 in which a browser program is installed. PCs 301 to 305 that serve as clients communicate with workflow management apparatus 100 so as to receive a workflow and display a process defined by the workflow. Further, when a user executes the process defined by the workflow, PCs 301 to 305 accept and transmit the result to workflow management apparatus 100. Moreover, although the example is illustrated here in which workflow management apparatus 100 serves as a Web server and PCs 301 to 305 serve as clients that execute the browser program, apart from this example, the system may be one in which PCs 301 to 305 and workflow management apparatus 100 have a program for their mutual communication installed therein, and workflow management apparatus 100 becomes a server and PCs 301 to 305 become the clients.

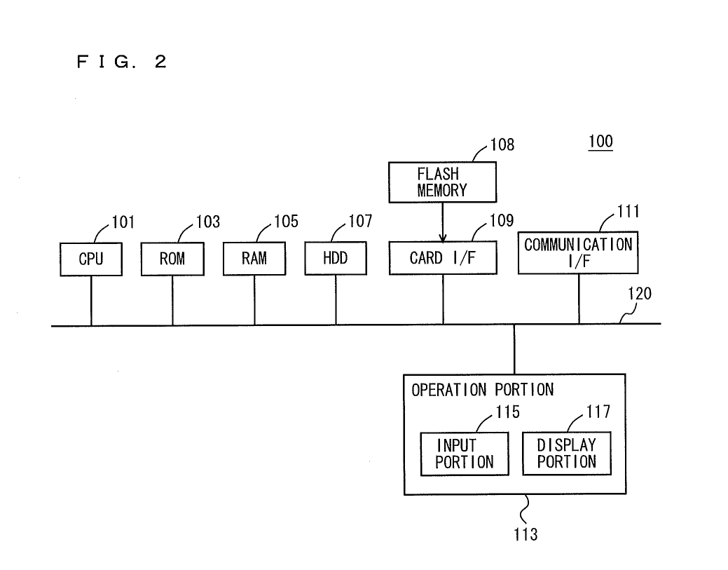

FIG. 2 is a block diagram showing one example of the hardware arrangement of the workflow management apparatus. With reference to FIG. 2, workflow management apparatus 100 includes, each respectively connected to a bus 120, a central processing unit (CPU) 101, a ROM (Read Only Memory) 103 for storing a program and the like to be executed by CPU 101, a RAM (Random Access Memory) 105 to be used as a work area of CPU 101, a hard disk drive (HDD) 107 serving as a mass storage device, a communication interface (I/F) 111 for connecting workflow management apparatus 100 to network 3, an operation portion 113 that forms an interface with a user, and a card interface (I/F) 109 to which a flash memory 108 is attached.

CPU 101 controls the entire workflow management apparatus 100. In addition, CPU 101 loads onto RAM 105 and executes a workflow management program and a schedule management program stored in ROM 103. Moreover, CPU 101 may load onto RAM 105 and execute a workflow management program and a schedule management program stored in flash memory 108 via card I/F 109.

Operation portion 113 includes an input portion 115 including a keyboard and a pointing device such as a mouse and a display portion 117 formed by an organic ELD (Electro Luminescence Display) and the like or a liquid crystal display for displaying data.

Moreover, the storage media for storing a program to be executed by CPU 101 is not limited to flash memory 108, and may also be media such as a flexible disk, a cassette tape, an optical disk [CD-ROM (Compact Disc-Read Only Memory)/MO (Magnetic Optical Disc)/MD (Mini Disc)/DVD (Digital Versatile Disc)], an IC card, an optical card, and a semiconductor memory such as a mask ROM, an EPROM (Erasable Programmable Read Only Memory), an EEPROM (Electrically Erasable Programmable Read Only Memory), and the like.

Furthermore, CPU 101 may download the workflow management program or the schedule management program from a computer connected to the Internet and store it in HDD 107, or the computer connected to the Internet may write the workflow management program or the schedule management program into HDD 107 and CPU 101 may execute it. The workflow management program or the schedule management program referred to here includes not only a program directly executable by CPU 101, but also a source program, a compressed program, an encrypted program, and the like.

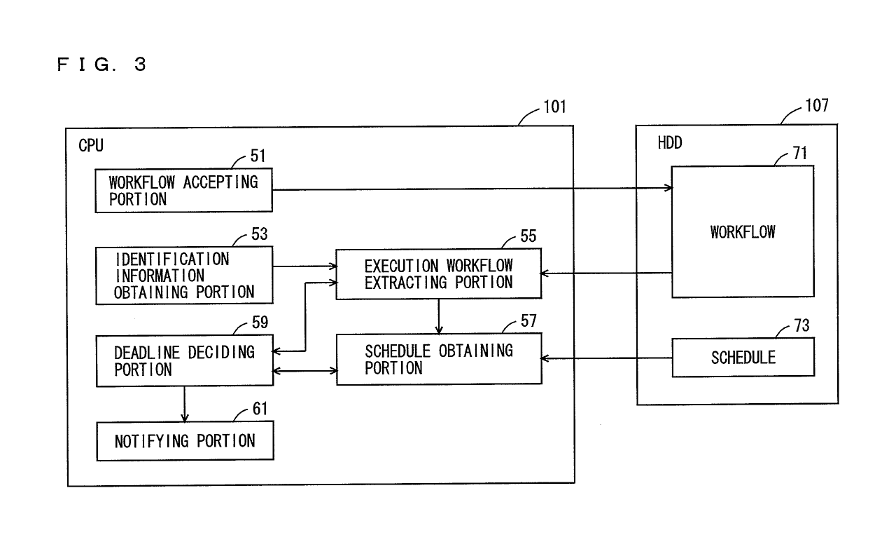

FIG. 3 is a functional block diagram showing one example of a function of a CPU provided in the workflow management apparatus. With reference to FIG. 3, CPU 101 provided in workflow management apparatus 100 includes a workflow accepting portion 51 to accept and store a workflow, an identification information obtaining portion 53 to obtain user identification information for identifying a worker, an execution workflow extracting portion 55 to extract from stored workflows an execution workflow which assigns a target process that is to be the object of execution to the worker, a schedule obtaining portion 57 to obtain a schedule of a worker assigned to a post-process that comes later in sequential order than the target process defined by the execution workflow, a deadline deciding portion 59 to decide on a deadline for the execution of the target process based on the obtained schedule, and a notifying portion 61 to notify the decided deadline.

Workflow accepting portion 51 accepts an instruction to register a workflow, generates a workflow according to the accepted instruction, and stores it in HDD 107. In this manner, a workflow 71 is stored in HDD 107. Workflow accepting portion 51 accepts the instruction to register the workflow when communication I/F 111 receives the instruction to register the workflow from any one of PCs 301 to 305. The instruction to register the workflow at least includes a plurality of processes whose order is determined in advance and the identification information for identifying the worker assigned to each of the plurality of processes. Here, the case will be described in which the workflow for circulating a document in order to have a plurality of persons execute the process of approving the document is registered. The document described here is digitized data and is, for instance, data generated by a computer as the computer executes an application program. The instruction to register a workflow further includes the document which is to be the object of circulation.

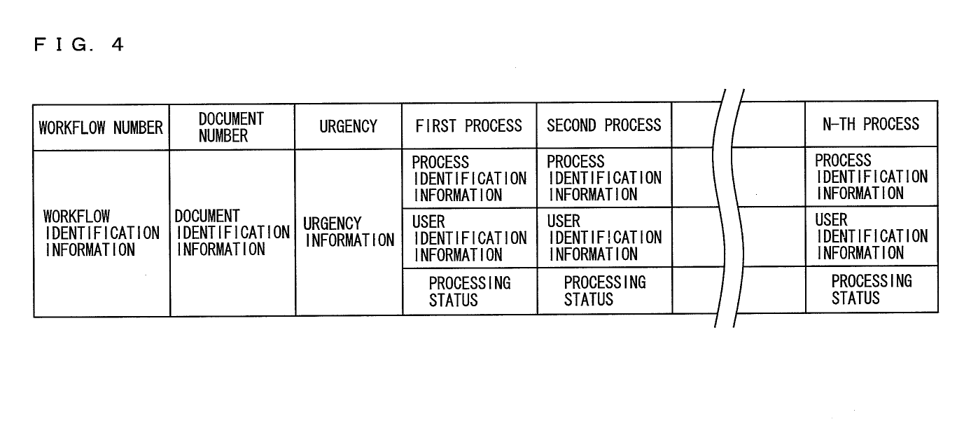

FIG. 4 is a diagram illustrating one example of a format of a workflow. With reference to FIG. 4, the workflow includes the item of workflow number, the item of document number, the item of urgency, and N-items of the first process to the N-th process. Here, the format of the workflow that defines N-processes is illustrated. In the item of workflow number, workflow identification information for identifying a workflow is set. The workflow identification information is a number that workflow accepting portion 51 gives to the workflow, and it is described here as being a serial number. In the item of document number, document identification information for identifying the document to be the object of circulation that is included in the instruction to register the workflow is set. Workflow accepting portion 51 stores the document itself in a predetermined area of HDD 107 and sets the document identification information for identifying the stored document in the item of document number. In the item of urgency, urgency information is set that indicates whether the workflow is one that needs to be executed immediately or not. The item of urgency is set to urgent when the instruction to register the workflow includes information indicating that it is urgent, and is set to normal when such information is not included.

In the items of the first process to the N-th process, process identification information for identifying the processes to be executed first to N-th (where N is a positive integer), user identification information for identifying the workers assigned to the processes, and the processing statuses are respectively set. Since the example described here is one in which the workflow defines the process of approving a document, the process identification information for identifying the approving process is set, and the user identification information for identifying the workers assigned to that approving process is also set.

For instance, in the case of the workflow in which a document is to be approved by user A, user B, and user C in this order, the process identification information for identifying the approving process and the user identification information for identifying user A are set in the item of the first process, the process identification information for identifying the approving process and the user identification information for identifying user B are set in the item of the second process, and the process identification information for identifying the approving process and the user identification information for identifying user C are set in the item of the third process.

As for the processing status, status information is set which indicates whether the process is in the status of having been executed or in the status of not having been executed. Here, as the status information, “processed” is set if the process is in the status of having been executed, and “unprocessed” is set if the process is in the status of not having been executed. Since workflow 71 defines a plurality of processes whose order is determined in advance, the process to be executed next is determined by the processing status. While the processing statuses are all set to “unprocessed” at the time the workflow is generated, they are updated to “processed” in the predetermined order. Consequently, among the processes whose processing statuses are set to “unprocessed,” the process whose order is the earliest is the process to be executed next. Here, the process to be executed next is referred to as a target process. A target process is the process that becomes the object of execution next.

Going back to FIG. 3, identification information obtaining portion 53 obtains the user identification information for identifying the worker which is to be the target of processing by workflow management apparatus 100 and outputs the obtained user identification information to execution workflow extracting portion 55. More specifically, in the case where a user operates PC 301 to log onto workflow management apparatus 100, for instance, PC 301 transmits a logon request to workflow management apparatus 100, while workflow management apparatus 100 requests for the input of the user identification information to PC 301 and obtains the user identification information inputted into PC 301 by the worker in response to the request. The method of logging onto workflow management apparatus 100 is not limited to this, and a conventional well-known technology may be used. Moreover, when an instruction to view a workflow is accepted from one of PCs 301 to 305, identification information obtaining portion 53 requests for the input of the user identification information to PC 301 and obtains the user identification information inputted into PC 301 by the worker in response to the request. The instruction to view a workflow is accepted when workflow management apparatus 100 does not request a logon. In addition, even in the case where workflow management apparatus 100 does request a logon, the user identification information is obtained if the instruction to view a workflow is accepted from one of PCs 301 to 305 after the logon.

Execution workflow extracting portion 55 extracts from workflows 71 stored in HDD 107 as an execution workflow the workflow that assigns a target process to the worker of the user identification information inputted from identification information obtaining portion 53, or in other words, the worker who has logged on. More specifically, the target process of each of a plurality of workflows 71 stored in HDD 107 is specified, and workflow 71 in which the user identification information assigned to its target process is the same as the user identification information inputted from identification information obtaining portion 53 is extracted as the execution workflow. An execution workflow is the workflow that defines the process to be executed by the user who has logged on. Execution workflow extracting portion 55 outputs the extracted execution workflow to schedule obtaining portion 57.

When the processing mode is set to the normal processing mode, schedule obtaining portion 57 obtains the schedule of a worker assigned to a post-process that comes later in sequential order than the target process defined by the execution workflow inputted from execution workflow extracting portion 55. In other words, the schedule of the worker who is to execute the process that comes after the target process assigned to the logged-on user is obtained. More specifically, the process identification information of the process which is the earliest in sequential order among those having the processing status defined as “unprocessed” among a plurality of processes defined by the execution workflow is the process identification information of the target process. If the sequential order of the target process is second, for instance, the sequential order immediately after the target process is third. Therefore, the worker specified by the user identification information set in the item of third process is the worker assigned to the post-process that comes after the target process in sequential order. Schedule obtaining portion 57 extracts the schedule which includes the user identification information of the worker assigned to the process that comes after the target process in sequential order, or here, the user identification information set in the item of third process, from schedules 73 stored in HDD 107. Schedule obtaining portion 57 outputs the extracted schedule 73 and the execution workflow as a set to deadline deciding portion 59.

In the case where a plurality of execution workflows are inputted from execution workflow extracting portion 55, schedule obtaining portion 57 obtains the schedule of the worker assigned to the post-process for each of a plurality of execution workflows and outputs a plurality of sets of the obtained schedule and the execution workflow.

In addition, when the processing mode is set to the all processing mode, schedule obtaining portion 57 obtains the schedule of the worker of each of all the user identification information assigned to each of all the processes that come after the target process and outputs all the schedules obtained to deadline deciding portion 59. For instance, if the sequential order of the target process is second, and a third process and a fourth process are defined as the processes following the target process, the schedule of the worker assigned to the third process and the schedule of the worker assigned to the fourth process are respectively extracted from HDD 107, and the set of the respective schedules of the two workers extracted and the execution workflow is outputted to deadline deciding portion 59.

Deadline deciding portion 59 decides on a deadline for the execution of the target process based on the set of an execution workflow and a schedule inputted from schedule obtaining portion 57, and outputs the decided deadline to notifying portion 61. The deadline for the execution of the target process indicates the final date by which the target process must be executed. Upon deciding on a deadline, deadline deciding portion 59 first decides on a starting deadline and a final deadline, and decides on one of the days between and including the starting deadline and the final deadline to be the deadline. Moreover, although the example here is illustrated in terms of unit of day in deciding on the deadline, it may be decided in unit of hours, minutes, and seconds.

More specifically, when the processing mode is set to the normal processing mode, deadline deciding portion 59 first determines whether or not a period of downtime is included in the schedule inputted from schedule obtaining portion 57. A period of downtime is the period during which work cannot be performed. If the schedule includes a period of downtime, deadline deciding portion 59 sets the day which is one day previous to the first day of the period of downtime as the final deadline.

When the processing mode is set to the all processing mode, there are cases in which the set of an execution workflow and a schedule inputted from schedule obtaining portion 57 includes a plurality of schedules for a plurality of workers, and each of the plurality of schedules may include a period of downtime. In the case where a plurality of periods of downtime are included, deadline deciding portion 59 sets as the final deadline the day which is one day previous to the start date of the period of downtime whose start date is the earliest among the start dates of the plurality of periods of downtime.

Next, deadline deciding portion 59 decides on the starting deadline based on the amount of work of the worker who is assigned to the post-process that comes after the target process. More specifically, deadline deciding portion 59 outputs the user identification information for identifying the worker assigned to the post-process to execution workflow extracting portion 55 and requests execution workflow extracting portion 55 to obtain a post-process workflow of the worker of the post-process. A post-process workflow is the workflow that defines the target process to be executed by the worker assigned to the post-process.

Execution workflow extracting portion 55 extracts from workflows 71 stored in HDD 107 the workflow that defines the target process being assigned to the worker of the user identification information inputted from deadline deciding portion 59 as the post-process workflow. More specifically, the target process of each of a plurality of workflows 71 stored in HDD 107 is specified, and workflow 71 in which the user identification information assigned to its target process is the same as the user identification information inputted from deadline deciding portion 59 is extracted as the post-process workflow. Execution workflow extracting portion 55 outputs the extracted post-process workflow to deadline deciding portion 59. In the case where a plurality of post-process workflows are extracted, execution workflow extracting portion 55 outputs the plurality of extracted post-process workflows to deadline deciding portion 59.

Deadline deciding portion 59 decides on the starting deadline based on the post-process workflow inputted from execution workflow extracting portion 55. More specifically, the time in which the worker assigned to the post-process executes the target process defined by the post-process workflow is calculated, and the calculated time is allotted to the unoccupied hours in the schedule of the worker assigned to the post-process. Here, the time period to which the time for the execution by the worker is allotted is referred to as an execution time period. The schedule of the worker assigned to the post-process is the schedule inputted from schedule obtaining portion 57. Deadline deciding portion 59 allots the time for the execution by the worker, starting from earlier unoccupied hours. The time for the execution by the worker may be determined in advance in correspondence to the target process, or the track record of the time in which the worker assigned to the post-process executes an approval process may be stored and the time for the execution of the target process may be decided based on the stored track record. The track record of the time of execution of an approval process is the duration of time from the time the target process comes into being for the worker, or in other words, from the time the approving process, which is the process that comes before the target process, is executed, up to the time the worker executes the approving process which is the target process. In the case where a plurality of post-process workflows are inputted, deadline deciding portion 59 allots the time for the execution of the target process assigned to the worker assigned to the post-process in each of the plurality of post-process workflows to the unoccupied hours in the schedule one by one in order.

After allotting the execution time, deadline deciding portion 59 decides on the earliest day within the unoccupied hours in the schedule of the worker assigned to the post-process to be a starting deadline. Then, one of the days between and including the starting deadline and the final deadline decided in advance is set as the deadline. Any given day between the starting deadline and the final deadline may be set as the deadline. Here, of the given days, the starting deadline is set as the deadline. Moreover, if the set starting deadline is later than the final deadline, the final deadline is set to be the deadline.

Notifying portion 61 transmits an overview list of one or more target processes defined by one or more execution workflows extracted by execution workflow extracting portion 55 to one of PCs 301 to 305 which the worker who has logged on operates. In the case where a plurality of execution workflows are extracted by execution workflow extracting portion 55, the overview list of the target processes arranged in order starting from the target process whose deadline decided by deadline deciding portion 59 is the earliest is transmitted. In addition, notifying portion 61 transmits the overview list of the execution workflows extracted by execution workflow extracting portion 55 while differentiating the execution workflows having “urgent” set in the item of urgency from other execution workflows. For instance, the overview list in which the execution workflows having “urgent” set in the item of urgency are differentiated from other execution workflows in the manner they are displayed, such as in different color, different character font and the like is transmitted.

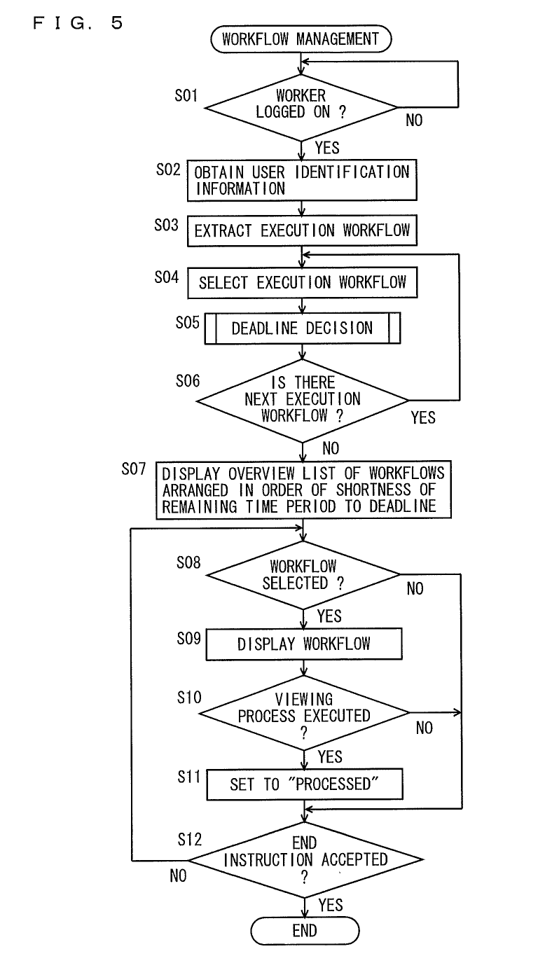

FIG. 5 is a flow chart showing one example of the flow of a workflow management process. A workflow management process is a process executed by CPU 101 provided in workflow management apparatus 100 when CPU 101 executes a workflow management program With reference to FIG. 5, CPU 101 determines whether a worker has logged on or not (step S01). The process stands by until the worker logs on (NO in step S01), and it proceeds to step S02 when the worker logs on. In step S02, the user identification information for identifying the logged-on worker is obtained.

From among workflows 71 stored in HDD 107, the workflow that assigns a target process to the logged-on worker is extracted as an execution workflow (step S03). More specifically, the target process of each of a plurality of workflows 71 stored in HDD 107 is specified, and workflow 71 in which the user identification information assigned to its target process is the same as the user identification information obtained in step S02 is extracted as the execution workflow. In the case in which a plurality of execution workflows are stored, all the execution workflows are extracted.

In the next step S04, one of the execution workflows extracted in step S03 is selected as the object of processing. Then, a deadline decision process is executed (step S05). While the deadline decision process will be described later, it is a process of deciding on a deadline for the execution of the target process defined by the execution workflow selected in step S04. In the next step S06, it is determined whether or not there is an execution workflow that has not yet been selected as the object of processing among the execution workflows extracted in step S03. If an unprocessed execution workflow exists, the process returns to step S04, but if it does not exist, the process proceeds to step S07.

In step S07, a workflow overview list is displayed in which workflows are arranged in order starting from the workflow whose remaining time period up to the deadline is the shortest. More specifically, a workflow overview list is generated in which the workflow numbers and the document numbers of the execution workflows extracted in step S03 are arranged in order starting from those whose deadline decided in step S05 is the earliest and in which the deadline is provided on the side for each workflow. Then, the generated workflow overview list is transmitted via communication I/F 111 to the PC among PCs 301 to 305 that is operated by the worker who has logged on. Consequently, the workflow overview list is displayed on the PC among PCs 301 to 305 that is operated by the logged-on worker.

In the next step S08, it is determined whether one of the workflows displayed in the overview list has been selected or not. If a workflow has been selected, the selected workflow is displayed (step S09). Here, the workflow identification information, the document identification information, and the user identification information and the processing statuses for all the workers in the sequential order are displayed. More specifically, the selected workflow is transmitted via communication I/F 111 to the PC among PCs 301 to 305 that is operated by the worker who has logged on. Thus, the workflow is displayed on the PC among PCs 301 to 305 that is operated by the logged-on worker.

In step S10, it is determined whether a viewing process has been executed or not. If the viewing process has been executed, the process proceeds to step S11, but if not, step S11 is skipped and the process proceeds to step S12. More specifically, it is determined whether the process of viewing and approving the document specified by the document identification information set in the item of document number of the workflow selected in step S08 has been executed by the user or not. When the user inputs the operation of approval into one of PCs 301 to 305 operated by the user, it is determined that the approving process has been executed. In step S11, the processing status in the item of the target process of the workflow selected in step S08 is changed to “processed”.

In step S12, it is determined whether an end instruction has been accepted or not. If the end instruction has been accepted, the process is terminated, but if not, the process returns to step S08. For instance, the end instruction is accepted when the operation of logoff has been accepted.

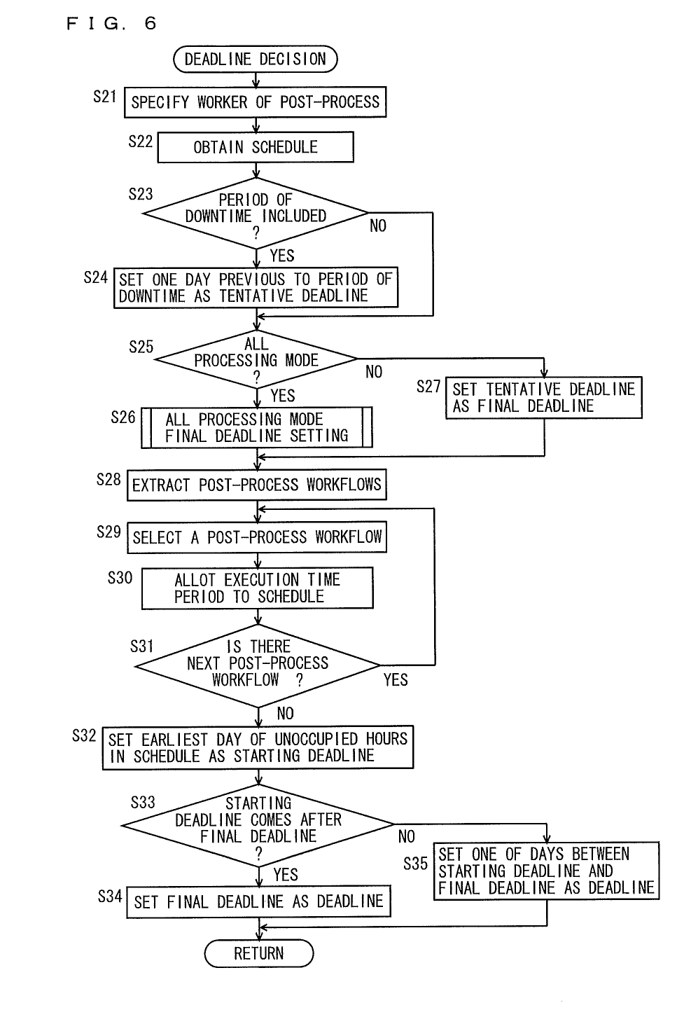

FIG. 6 is a flow chart showing one example of the flow of a deadline decision process. The deadline decision process is the process executed in step S05 of FIG. 5. With reference to FIG. 6, CPU 101 specifies the worker of the post-process (step S21). The worker assigned to the post-process that comes later in sequential order than the target process of the execution workflow is specified. More specifically, the user identification information associated with the post-process that comes later in sequential order than the target process of the execution workflow is obtained.

In the next step S22, the schedule of the worker assigned to the post-process is obtained. More specifically, the schedule that includes the user identification information of the worker specified in step S21 is extracted from schedules 73 stored in HDD 107.

In the next step S23, it is determined whether the obtained schedule includes a period of downtime or not. If the schedule includes a period of downtime, the process proceeds to step S24, but if not, step S24 is skipped and the process proceeds to step S25. In step S24, one day previous to the period of downtime is set as a tentative deadline. In step S25, it is determined whether the processing mode is set to the all processing mode or not. If it is set to the all processing mode, the process proceeds to step S26, but if not, the process proceeds to step S27. If it is not in the all processing mode, the tentative deadline set in step S24 is set as a final deadline in step S27, and the process proceeds to step S28.

In step S26, an all processing mode final deadline setting process is executed, and the process proceeds to step S28. While the all processing mode final deadline setting process will be described later, it is the process of setting a final deadline from the schedule of each of a plurality of workers respectively assigned to all the post-processes that come after a target process.

In step S28, one or more post-process workflows that respectively define one or more target processes of the worker of the post-process are extracted. Then, one is selected from the extracted post-process workflows as the object of processing (step S29). Further, the execution time period for executing the target process defined in the selected post-process workflow is allotted to the unoccupied hours in the schedule obtained in step S22 (step S30). More specifically, the time in which the worker assigned to the post-process executes the target process defined by the post-process workflow is calculated. Then, the calculated time (the execution time period) is allotted to the unoccupied hours in the schedule of the worker assigned to the post-process. The allotment of the execution time period to the schedule is done by allotting the execution time period in the schedule starting from earlier unoccupied hours.

In the next step S31, it is determined whether or not there is a post-process workflow that has not been selected in step S29 among the post-process workflows extracted in step S28. If a post-process workflow that is unselected as yet exists, the process returns to step S29, but if not, the process proceeds to step S32.

In step S32, the earliest day within the unoccupied hours in the schedule to which the execution time period is assigned is set to be a starting deadline. Then, in the next step S33, it is determined whether or not the starting deadline set in step S32 comes after the final deadline set in step S26 or in step S27. If the starting deadline comes after the final deadline, the process proceeds to step S34, but if not, the process proceeds to step S35. In step S34, the final deadline is set as the deadline, and the process returns to the workflow management process. On the other hand, in step S35, one of the days between and including the starting deadline and the final deadline is set as the deadline, and the process returns to the workflow management process. Any given day between the starting deadline and the final deadline may be set as the deadline. Here, the starting deadline is set as the deadline.

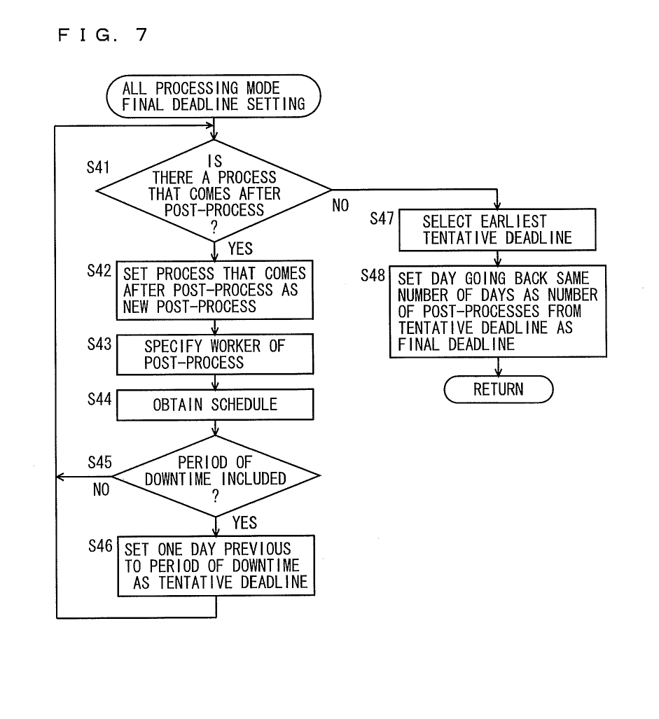

FIG. 7 is a flow chart showing one example of the flow of the all processing mode final deadline setting process. The all processing mode final deadline setting process is the process executed in step S26 of FIG. 6. With reference to FIG. 7, CPU 101 determines whether a process that comes after the post-process exists in the execution workflow or not (step S41). If a process that comes after the post-process exists, the setting process proceeds to step S42, but if not, the setting process proceeds to step S47. In step S42, the process that comes later in sequential order than the post-process is set to be the new post-process. Then, the worker assigned to the newly set post-process is specified. For instance, if the post-process is the process that is second in sequential order, the user identification information set in the item of second process of the execution workflow is obtained.

In the next step S44, the schedule of the worker specified in step S43 is obtained. More specifically, the schedule that includes the user identification information of the worker obtained in step S43 is extracted from schedules 73 stored in HDD 107. Then, it is determined whether the obtained schedule includes a period of downtime or not (step S45). If a period of downtime is included, the process proceeds to step S46, but if not, the process returns to step S41. In step S46, one day previous to the period of downtime is set as a tentative deadline, and the process returns to step S41. In step S41 executed next, it is determined whether a process that comes even later than the newly set post-process exists or not, and if such a process exists, that process is set anew to be the post-process in step S42. Therefore, a plurality of workers are specified who are respectively assigned to all of the plurality of processes that come later in sequential order than the target process of the logged-on worker among the plurality of processes defined by the execution workflow, and a plurality of tentative deadlines are set based on the respective schedules of the plurality of workers specified.

In step S47, the earliest tentative deadline among the plurality of tentative deadlines is selected. Then, the day that goes back the same number of days as the number of the post-processes from the selected tentative deadline is set as the final deadline (step S48), and the process returns to the deadline decision process. More specifically, there may be the case in which a plurality of processes exist before the target process that was the basis for setting of the selected tentative deadline and the target process of the user who logged on before the previous day of the selected tentative deadline. In order to secure one day for each of the plurality of processes to be executed, the day that goes back the same number of days as the number of post-processes from the tentative deadline is set as the final deadline.

As described above, when the user identification information for identifying the worker who has logged on is obtained, workflow management apparatus 100 according to the present embodiment extracts from the workflows stored in HDD 107 an execution workflow which assigns the target process that is to be the object of execution to the logged-on worker, obtains the schedule of a worker assigned to a post-process that comes later in sequential order than the target process defined by the execution workflow, decides on a deadline for the execution of the target process based on the obtained schedule, and notifies the deadline. Thus, the deadline for the execution of the target process is notified based on the schedule of the worker who executes the post-process. As a result, if a user executes the target process defined by the workflow within the time frame before the deadline, a plurality of processes defined by the workflow will be executed smoothly.

In addition, in response to the operation of a worker logging onto workflow management apparatus 100 or the operation of the worker viewing a workflow being accepted, the user identification information of the worker who performed the logon operation or the operation of viewing the workflow is obtained, and the deadlines for the execution of the processes defined by the workflows are notified one by one in order from a more imminent deadline so that the chance of notifying the deadlines can be ensured.

Moreover, in the case where a plurality of execution workflows are extracted, the deadline for executing the target process is decided in each of the plurality of execution workflows, and the plurality of execution workflows are notified, with ones having a shorter remaining time period before the deadline given higher priority. Thus, the worker only needs to execute the processes one by one in order starting with one having a shorter remaining time period before the deadline so that the user may be notified in a manner that allows a plurality of workflows to be executed efficiently.

Further, in the case where a period of downtime that is longer than a prescribed period is set in the schedule of a worker of the post-process, the deadline is decided to be a day that comes before this period of downtime so that the post-process can be made available to the subsequent worker for execution before it becomes impossible for the subsequent worker to execute the process. Thus, the situation can be prevented in which the subsequent worker becomes unable to execute the post-process, leaving the workflow unprocessed and neglected for an extended period of time.

Furthermore, in the case where there are a plurality of post-processes and where a plurality of schedules respectively corresponding to a plurality of workers respectively assigned to the plurality of post-processes are obtained and a period of downtime during which work cannot be performed that is longer than a prescribed period is set in at least one of the plurality of schedules obtained, the deadline is decided to be before the earliest time period of at least one period of downtime set in at least one of the plurality of schedules. Thus, before the plurality of workers respectively assigned to the plurality of post-processes become unable to execute the processes, the workflow can be passed on to a plurality of subsequent workers to whom the plurality of post-processes are assigned so that, during the time in which the plurality of processes defined by the workflow are being processed to the end, it is possible to prevent the processes from being left neglected for an extended period of time.

In addition, for the worker assigned to a post-process, the execution time period for executing a separately assigned target process is allotted to the unoccupied hours in the schedule of that worker, and the deadline is decided to be subsequent to the allotted execution time period. Thus, the deadline will be set to be after the time the worker of the post-process is able to execute the post-process so that extension time can be given while the worker of the post-process is unable to execute the post-process.

Moreover, the schedule defines the execution time period allotted for the execution of the target process defined by the workflow so that, if a new workflow is accepted after the schedule has been established, the information which allows the plurality of processes defined by the new workflow to flow smoothly can be provided.

In addition, although workflow management system 1 is illustrated in the above-described embodiment, the present invention can be construed as a workflow management method or a workflow management program that causes workflow management apparatus 100 to execute the workflow management process described in FIGS. 5 to 7.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A workflow management apparatus, comprising:
a workflow accepting portion to accept and store a workflow that includes a plurality of processes whose order is determined in advance and respectively assigns each of said plurality of processes to one person who is selected from a plurality of workers;
an identification information obtaining portion to obtain identification information for identifying a worker;
an execution workflow extracting portion to extract from the stored workflows an execution workflow which assigns a target process that is to be an object of execution to said worker of the identification information obtained;
a schedule obtaining portion to obtain a schedule of a worker assigned to a post-process that comes later in sequential order than said target process defined by said execution workflow;
a deadline deciding portion to decide on a deadline for execution of said target process based on said schedule obtained; and
a notifying portion to notify the decided deadline to the worker to whom said target process is assigned.

2. The workflow management apparatus according to claim 1, wherein said identification information obtaining portion obtains identification information of a worker in response to accepting a prescribed operation by the worker.

3. The workflow management apparatus according to claim 1, wherein
said schedule obtaining portion, in a case where a plurality of said execution workflows are extracted, obtains a schedule of a worker assigned to a post-process that comes later in sequential order than a target process in each of said plurality of execution workflows,
said deadline deciding portion decides on a deadline for execution of the target process based on the schedule obtained for each of said plurality of execution workflows, and
said notifying portion notifies of said plurality of execution workflows in such order that one having a shorter remaining time period before a deadline is given a higher priority, based on a plurality of deadlines respectively decided for a plurality of target processes respectively defined by said plurality of execution workflows.

4. The workflow management apparatus according to claim 1, wherein, in a case where a period of downtime in which work cannot be performed that is longer than a prescribed period is set in said schedule obtained, said deadline deciding portion decides on a deadline to be a day that comes before the period of downtime.

5. The workflow management apparatus according to claim 4, wherein
said schedule obtaining portion, in a case where there are a plurality of said post-processes, obtains a plurality of schedules respectively corresponding to a plurality of workers respectively assigned to said plurality of post-processes, and
said deadline deciding portion, in a case where a period of downtime in which work cannot be performed that is longer than a prescribed period is set in at least one of said plurality of schedules obtained, decides on a deadline to be before an earliest time period of at least one period of downtime set in at least one of the plurality of schedules.

6. The workflow management apparatus according to claim 4, wherein said deadline deciding portion includes
a post-process workflow extracting portion to extract a post-process workflow in which a target process that is to be an object of execution among a plurality of processes defined by said workflow stored is assigned to a worker assigned to a post-process that comes later in sequential order than a target process that is to be an object of execution among a plurality of processes defined by said execution workflow extracted, and
an allotting portion to allot to unoccupied hours in said schedule obtained, an execution time period for the worker assigned to said post-process to execute a target process defined for the worker assigned to said post-process by said post-process workflow extracted, and wherein
said deadline deciding portion decides on a deadline to be subsequent to the allotted execution time period in the schedule in which said execution time period is allotted.

7. The workflow management apparatus according to claim 1, wherein said schedule defines an execution time period allotted for execution of said target process defined by said workflow.

8. A workflow management method, comprising the steps of:
accepting and storing a workflow that includes a plurality of processes whose order is determined in advance and respectively assigns each of said plurality of processes to one person who is selected from a plurality of workers;
obtaining identification information for identifying a worker;
extracting from the stored workflows an execution workflow which assigns a target process that is to be an object of execution to said worker of the identification information obtained;
obtaining a schedule of a worker assigned to a post-process that comes later in sequential order than said target process defined by said execution workflow;
deciding on a deadline for execution of said target process based on said schedule obtained; and
notifying the decided deadline to the worker to whom said target process is assigned.

9. The workflow management method according to claim 8, wherein said step of obtaining the identification information includes a step of obtaining the identification information of a worker in response to accepting a prescribed operation by the worker.

10. The workflow management method according to claim 8, wherein,
in a case where a plurality of said execution workflows are extracted, said step of obtaining a schedule includes a step of obtaining a schedule of a worker assigned to a post-process that comes later in sequential order than a target process in each of said plurality of execution workflows,
said step of deciding on a deadline includes a step of deciding on a deadline for execution of the target process based on the schedule obtained for each of said plurality of execution workflows, and
said notifying step includes a step of notifying of said plurality of execution workflows in such order that one having a shorter remaining time period before a deadline is given a higher priority, based on a plurality of deadlines respectively decided for a plurality of target processes respectively defined by said plurality of execution workflows.

11. The workflow management method according to claim 8, wherein, in a case where a period of downtime in which work cannot be performed that is longer than a prescribed period is set in said schedule obtained, said step of deciding on a deadline includes a step of deciding on a deadline to be a day that comes before the period of downtime.

12. The workflow management method according to claim 11, wherein,
in a case where there are a plurality of said post-processes, said step of obtaining a schedule includes a step of obtaining a plurality of schedules respectively corresponding to a plurality of workers respectively assigned to said plurality of post-processes, and wherein,
in a case where a period of downtime in which work cannot be performed that is longer than a prescribed period is set in at least one of said plurality of schedules obtained, said step of deciding on a deadline includes a step of deciding on a deadline to be before an earliest time period of at least one period of downtime set in at least one of the plurality of schedules.

13. The workflow management method according to claim 11, wherein said step of deciding on a deadline includes the steps of:
extracting a post-process workflow in which a target process that is to be an object of execution among a plurality of processes defined by said workflow stored is assigned to a worker assigned to a post-process that comes later in sequential order than a target process that is to be an object of execution among a plurality of processes defined by said execution workflow extracted;
allotting to unoccupied hours in said schedule obtained, an execution time period for the worker assigned to said post-process to execute a target process defined for the worker assigned to said post-process by said post-process workflow extracted; and
deciding on a deadline to be subsequent to the allotted execution time period in the schedule in which said execution time period is allotted.

14. The workflow management method according to claim 8, wherein said schedule defines an execution time period allotted for execution of said target process defined by said workflow.

15. A workflow management program embodied on a computer-readable medium which causes a computer to execute the steps of:
accepting and storing a workflow that includes a plurality of processes whose order is determined in advance and respectively assigns each of said plurality of processes to one person who is selected from a plurality of workers;
obtaining identification information for identifying a worker;
extracting from the stored workflows an execution workflow which assigns a target process that is to be an object of execution to said worker of the identification information obtained;
obtaining a schedule of a worker assigned to a post-process that comes later in sequential order than said target process defined by said execution workflow;
deciding on a deadline for execution of said target process based on said schedule obtained; and
notifying the decided deadline to the worker to whom said target process is assigned.

16. The workflow management program according to claim 15, wherein said step of obtaining the identification information includes a step of obtaining the identification information of a worker in response to accepting a prescribed operation by the worker.

17. The workflow management program according to claim 15, wherein,
in a case where a plurality of said execution workflows are extracted, said step of obtaining a schedule includes a step of obtaining a schedule of a worker assigned to a post-process that comes later in sequential order than a target process in each of said plurality of execution workflows,
said step of deciding on a deadline includes a step of deciding on a deadline for execution of the target process based on the schedule obtained for each of said plurality of execution workflows, and
said notifying step includes a step of notifying of said plurality of execution workflows in such order that one having a shorter remaining time period before a deadline is given a higher priority, based on a plurality of deadlines respectively decided for a plurality of target processes respectively defined by said plurality of execution workflows.

18. The workflow management program according to claim 15, wherein, in a case where a period of downtime in which work cannot be performed that is longer than a prescribed period is set in said schedule obtained, said step of deciding on a deadline includes a step of deciding on a deadline to be a day that comes before the period of downtime.

19. The workflow management program according to claim 18, wherein,
in a case where there are a plurality of said post-processes, said step of obtaining a schedule includes a step of obtaining a plurality of schedules respectively corresponding to a plurality of workers respectively assigned to said plurality of post-processes, and wherein,
in a case where a period of downtime in which work cannot be performed that is longer than a prescribed period is set in at least one of said plurality of schedules obtained, said step of deciding on a deadline includes a step of deciding on a deadline to be before an earliest time period of at least one period of downtime set in at least one of the plurality of schedules.

20. The workflow management program according to claim 18, wherein said step of deciding on a deadline includes the steps of;
extracting a post-process workflow in which a target process that is to be an object of execution among a plurality of processes defined by said workflow stored is assigned to a worker assigned to a post-process that comes later in sequential order than a target process that is to be an object of execution among a plurality of processes defined by said execution workflow extracted;
allotting to unoccupied hours in said schedule obtained, an execution time period for the worker assigned to said post-process to execute a target process defined for the worker assigned to said post-process by said post-process workflow extracted; and
deciding on a deadline to be subsequent to the allotted execution time period in the schedule in which said execution time period is allotted.

21. The workflow management program according to claim 15, wherein said schedule defines an execution time period allotted for execution of said target process defined by said workflow.
